(19) United States
(12) Patent Application Publication
(10) Pub. No.: US 2011/0258538 A1
(43) Pub. Date: Oct. 20, 2011

(54) Capturing DOM Modifications Mediated by Decoupled Change Mechanism

(76) Inventors: Heng Liu, Alameda, CA (US); Rocky Kahn, Alameda, CA (US)

(21) Appl. No.: 13/077,348

(22) Filed: Mar. 31, 2011

Related U.S. Application Data
(60) Provisional application No. 61/319,825, filed on Mar. 31, 2010.

(51) Int. Cl. G06F 17/24

(52) U.S. Cl. 715/256

(57) ABSTRACT

A DOM-based document editing system is disclosed that maintains an editor DOM that can be modified by a user and includes an edit capture extension. The edit capture extension encodes a change to the editor DOM in a hierarchical coordinate format to identify a location of the change. Encoded changes can then be transferred to a collaborator and/or a persistence engine. The DOM-based document editing system optionally maintains a store DOM in addition to the editor DOM. The edit capture extension identifies changes in the editor DOM by comparing differences between the editor DOM and the store DOM. Identified changes are reflected in the store DOM to ensure that the two DOMs are substantially synchronized. Related changes can be grouped in a group step. The related changes are from either non-contiguous regions of the document or a plurality of editor DOMs. Related changes can be undone and/or redone as a group.

### CROSS-REFERENCE TO RELATED APPLICATIONS

This application claims the benefit of U.S. Provisional Application No. 61/319,825, filed Mar. 31, 2010, incorporated by reference herein.

### FIELD OF THE INVENTION

The present invention relates generally to a Document Object Model (DOM) application framework and, more particularly, to techniques for editing a document in such a DOM framework.

### BACKGROUND OF THE INVENTION

Generally, a Document Object Model (DOM) is a cross-platform and language-independent convention for representing and interacting with objects in HTML, XHTML and XML documents. Collaborative editing in web browsers has become commonplace with the advent of Writely, Zoho Write, Google Documents, Google Wave, Etherpad, and many others. Such systems “capture” user edits by a variety of means which can broadly be broken into two categories:
1. the JavaScript handles each keystroke; upon some threshold changes are persisted/sent to collaborators; or
2. the native editor (e.g. a web browser) mediates a user's edits to an editor DOM while the JavaScript periodically serializes the editor DOM (or a part thereof) and compares it to a serialized fulltext representation; any changes are identified and persisted/sent to collaborators; the serialized fulltext is updated to reflect the change. Collaborators' changes can modify the serialized fulltext which is then deserialized and substituted in whole or in part for the editor DOM.

The first method is quite complex, relying on JavaScript to handle most aspects of rich-text editing, which can slow down interactions while typing unless the system and document are carefully designed to permit efficient processing.

The second method may run more quickly while users type but requires considerable optimization to subsequently remain responsive to the user while the system processes changes. In processing changes, it is desirable to identify a “minimum change” which is the least verbose description of the edit that captures the change (i.e., if a user types a few characters to persist just those characters rather than including adjacent words or the entire paragraph). However, a straightforward approach—to execute a Unix-style difference operation between the two serialized fulltexts after every user change—is computationally expensive. Also, substituting a deserialized fulltext (as when applying collaborators' changes) can cause the editor display to flicker and interrupt a local user's interactions. The flicker and interruption can be minimized with additional optimization complexity.

Techniques are desired to support editing DOM-based documents where (i) the native editor handles most editing operations, (ii) minimum changes are efficiently identified, (iii) the DOM can contain arbitrary content (e.g., well-formed HTML) instead of being constrained to structures that can be edited efficiently, and (iv) the step capture and collaboration system can be programmed and maintained by a small number of developers (ideally one).

### SUMMARY OF THE INVENTION

Methods and apparatus are provided for editing DOM-based documents. According to one aspect of the invention, the disclosed DOM-based document editing system maintains an editor DOM that can be modified by a user and includes an edit capture extension. The edit capture extension encodes a change to the editor DOM in a hierarchical coordinate format to identify a location of the change. Encoded changes can then be transferred to a collaborator and/or a persistence engine.

According to another aspect of the invention, the disclosed DOM-based document editing system maintains two DOMs, namely, an editor DOM and a store DOM. As noted above, the editor DOM can be modified by a user and includes an edit capture extension. The edit capture extension identifies changes in the editor DOM by comparing differences between the editor DOM and the store DOM. Identified changes are reflected in the store DOM. In this manner, the editor DOM and the store DOM are maintained substantially synchronized.

According to yet another aspect of the invention, the disclosed DOM-based document editing system groups a plurality of related changes to one or more editor DOMs as a group step. The related changes in the group step are from non-contiguous regions of an editor DOM and/or from a plurality of editor DOMs. The related changes in the group step can be undone and/or redone as a group.

A more complete understanding of the present invention, as well as further features and advantages of the present invention, will be obtained by reference to the following detailed description and drawings.

### BRIEF DESCRIPTION OF THE DRAWINGS

FIG. 1 illustrates the order of operations for step capture.

FIG. 2 illustrates a computer system that may be used in an embodiment of the present invention.

FIG. 3 is an excerpt from the W3C Document Object Model Range definition.

FIG. 4 illustrates the data stores and actions which occur upon them.

FIG. 5 illustrates the relationship between ranges and coordinates.

FIG. 6 illustrates some examples of capturing beforeRange coordinates in store DOM.

FIG. 7 illustrates an element manipulation edit step.

FIG. 8 illustrates the determination of a superRange.

FIG. 9 illustrates the use of non-breaking spaces to show otherwise empty elements.

FIG. 10 illustrates an encoding of an edit step and group step.

FIG. 11 illustrates a collaborative, multi-section editing scenario where the effects of an undo can be discussed.

FIG. 12 illustrates the preservation of leaf node version to facilitate an intuitive undo/redo process.

### DETAILED DESCRIPTION

The present invention provides a DOM-based editor 22, shown in FIG. 4. As discussed hereinafter, the present invention employs a hierarchical coordinate format to identify locations of changes to a document. An edit capture extension can identify changes by comparing differences between editor DOM and store DOM versions of the document. Identified changes are reflected in the store DOM to ensure that the two DOMs are substantially synchronized. Related changes can be grouped in a group step, so that related changes can be undone and/or redone as a group.

Overview

Documents in DOM-based editors (editors) 22 may consist of text nodes and elements which modify the representation of text nodes. As shown in FIG. 4, there are various possible types of edit steps 2 that can change a document, including a replacement edit step 20 and an element manipulation edit steps 6.

Replacement edit steps 20 may consist of contiguous insertions, deletions, and/or replacements entered without an excessive pause or changing focus. For example, a user 446 may select a range “old, unnecessary text”, type “new stuff”, and then pause or click elsewhere in a document 480. When a user 446 types into an editor 22, the editor 22 collects a logical set of keystrokes into an edit step 2 which can later be undone or redone as a unit.

Element manipulation edit steps 6 may wrap or upwrap text nodes; or modify element attributes. For example, starting with a single text node “this is larger”, a user 446 may select the word “larger” and click <font size 10> command of the editor 22. The range is wrapped, creating a result, “This is <span style=“font-size: 10px”>larger</span>”. If the user 446 then increases the font size to 15 px, the span element attribute, style=“font-size: 10px”, is modified. If “larger” is reverted to default formatting, the <span> is removed (element is unwrapped).

In accordance with various aspects of the invention, following an edit step 2, the editor 22 updates the display, persists the edit step 2 to a persistence engine 438 and/or collaborators, appends the edit step 2 to an undo/redo queue 508, and performs any specialty manipulations supported by that editor 22 (e.g., Microsoft Word's “Smart Text” feature recognizes phone numbers, addresses, and Outlook contacts).

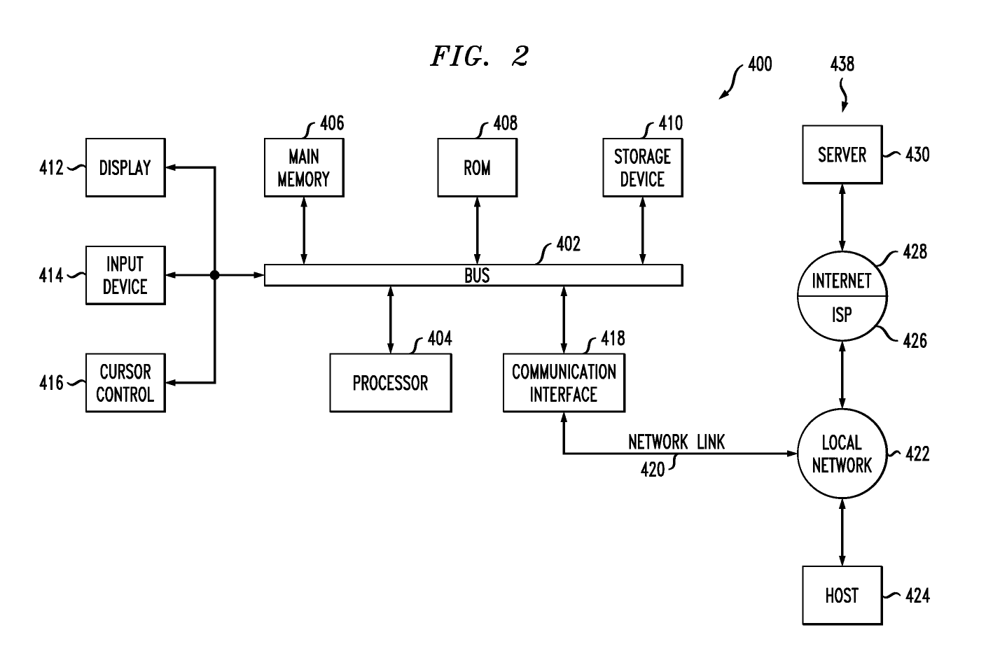

The editor 22 (e.g. a web browser element with asserted “content editable” attribute, as described at http://www.w3.org/TR/html5/editing.html#contenteditable) provided on a computer system 400 (as discussed further below in conjunction with FIG. 2) may lack features necessary for a particular application. For example, an application may require that edit steps 2 be instantly persisted to remote persistence engines 438 or collaborators. Edit capture extensions 431 may provide this missing functionality. Such an edit capture extension 431 may, most straightforwardly, be configured to process individual keystrokes. However, handling each keystroke independently can result in sluggish performance, especially for edit capture extensions 431 written in interpreted languages, such as JavaScript, and/or running on lower performance CPUs, such as mobile phones. In addition, handing keystrokes individually requires the edit capture extension 431 to itself mediate complex formatting; for example, when a user 446 presses backspace between two ordered list elements, the elements must be merged and following elements renumbered. For this reason, it's desirable to let the editor 22 handle the keystrokes while the edit capture extension 431 handles only those manipulations not supported by the editor 22.

The remainder of this disclosure describes the exemplary case where the editor 22 is a rich text control in a web browser (typically running compiled C++), the edit capture extension 431 is written in JavaScript, and the persistence engine 438 is on a remote server. Other implementations are possible; for example, the editor 22 could be a rich text control in an Adobe Air application, the edit capture extension 431 be written in ActionScript, and the persistence engine 438 can be on the local computer system 400.

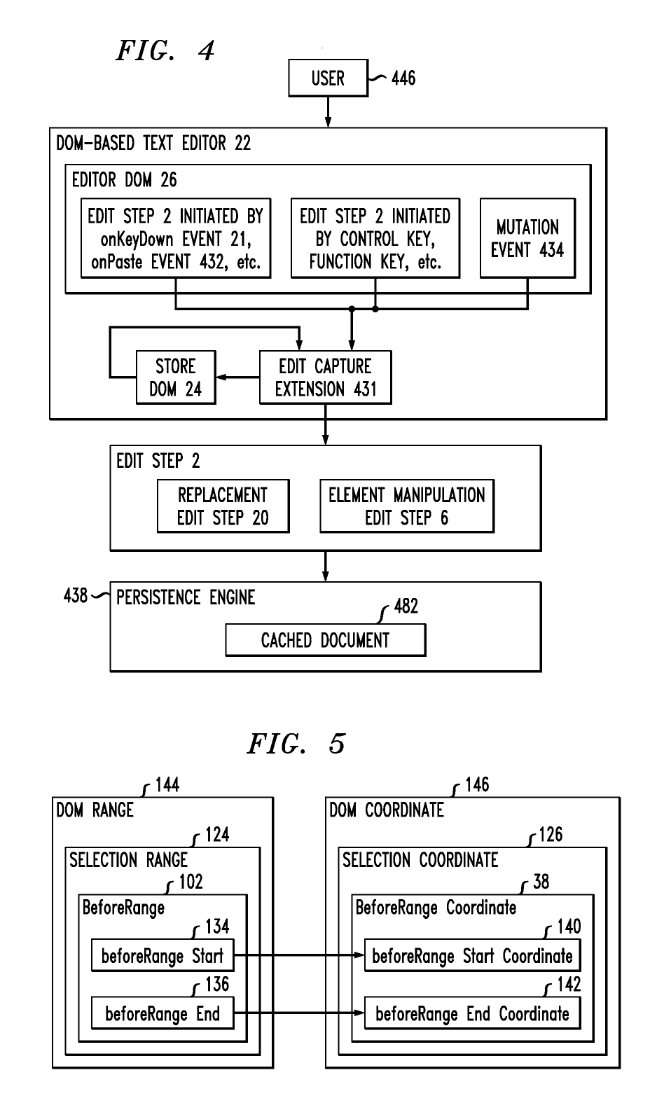

As previously indicated, an embodiment of the present invention provides a DOM-based editor 22 with a edit capture extension 431 configured to capture edit steps 2 (i.e., changes to an editor DOM 26) with help from a store DOM 24 that is kept in sync with editor DOM 26. An embodiment provides that edit steps 2 are encoded as DOM coordinates 146, as discussed further below in conjunction with FIG. 5. An embodiment provides means for a persistence engine 438 to more efficiently handle the resulting edit steps 2. An embodiment provides means to keep empty DOM elements navigable while editing. An embodiment provides support for mutation events 434. An embodiment demonstrates how edit steps 2 can be used in lieu of the native undo/redo functionality of the editor 22. An embodiment provides means to group related changes for purposes of undo/redo. An embodiment provides means to navigate a tree of revisions by remembering the active branch.

Embodiments of the present invention allow a DOM-based editor 22 (e.g. a web browser element with contenteditable attribute) in combination with an edit capture extension 431 to (i) handle most edits, (ii) efficiently identify minimum changes, (iii) incorporate remote collaborators' edits without interrupting the local user or causing the screen to flicker, and (iv) be programmed and maintained by a single developer.

For the remainder of this specification, a preamble, “In an embodiment of the present invention . . . ” may be inferred.

Initialization

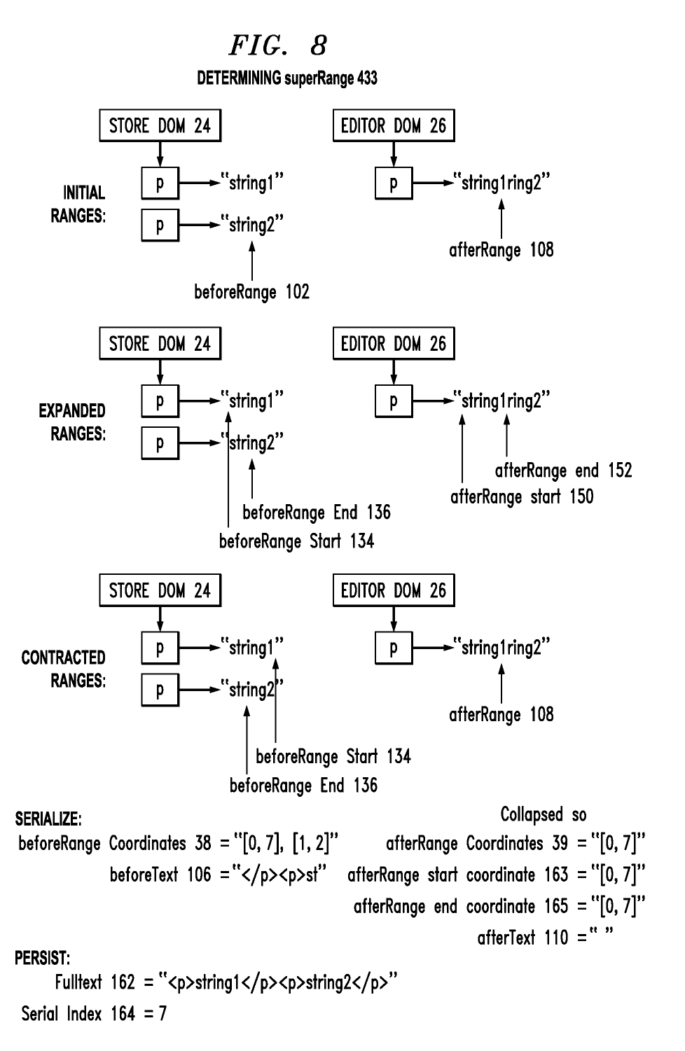

As shown in FIG. 4, an edit capture extension 431 running in a DOM-based editor 22 loads a document 480 from a persistence engine 438, usually in a serialized fulltext 162 format (FIG. 8). The editor 22 deserializes the fulltext 162 to generate an editor DOM 26 and, in some embodiments, a copy as a store DOM 24. In some embodiments, a document 480 may consist of multiple sections 457 (FIG. 11), each a separate editor DOM 26, and optionally of different data types (e.g., text, annotated image, etc). In some embodiments, the editor 22 may hide the document 480 or any number of sections 457 thereof (hiding or deleting the corresponding editor DOMs 26) while, if they exist, maintaining the corresponding store DOMs 24. In some embodiments, the editor 22 may show multiple representations of the same document 480 or one or more sections 457 thereof, perhaps in multiple panes in a browser window, in which case each pane would have a separate editor DOM 26 but may optionally share a single store DOM 24.

In a Model-View-Controller framework, the store DOM 24, if one exists, is the “model”, the editor DOM 26 is a “view”, and the edit capture extension 431 is the “controller”. Generally, the store DOM 24, if it exists, matches the contents of the editor DOM 26 except during the brief time before changes to the editor DOM 26 are reflected (copied) to the store DOM 24. There may also be times when the editor DOM 26 contains markup (annotations) that is not present in the store DOM 24, such as when displaying search highlighting or indicating where collaborators have recently made changes.

Note that the functionality of persistence engine 438 may be provided remotely (i.e., on a remote server), locally (i.e., operating on the same computer system as that running edit capture extension 431), or by a peer (as in peer-to-peer architecture).

Step Capture Summary

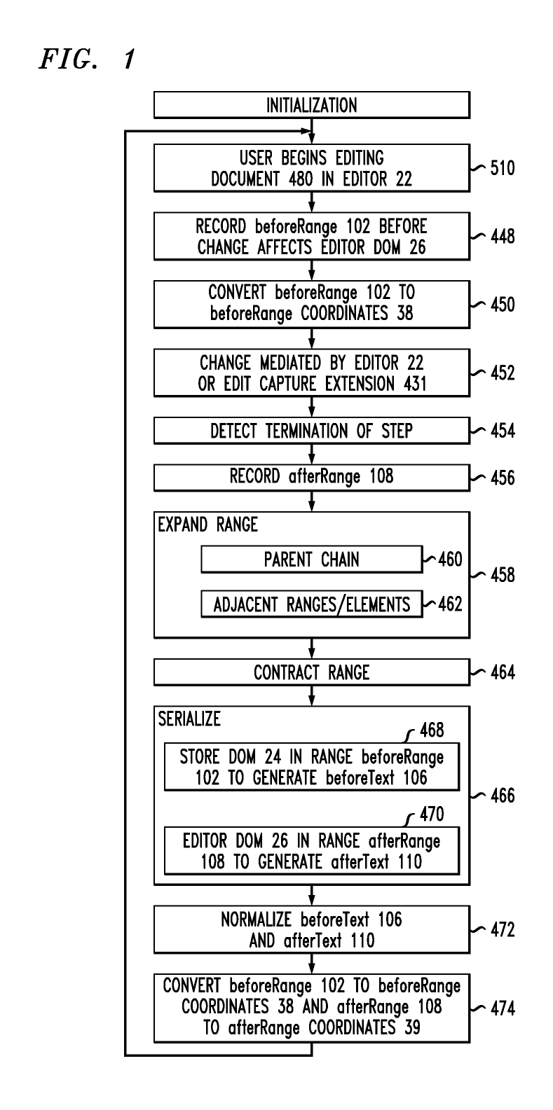

FIG. 1 illustrates the order of operations for step capture. As shown in FIG. 1, the edit capture extension 431 implements the following process to capture edit steps 2, the details of which will be subsequently expanded upon. During step capture phase 510, the user begins editing document 480 using the editor 22. Upon a beginning of an edit, the beforeRange 102 is recorded at step capture phase 448, before the change affects the editor DOM 26. During step capture phase 450, the beforeRange 102 is converted to beforeRange coordinates 38 (FIG. 5). During step capture phase 452, the change is mediated by editor 22 or edit capture extension 431. The termination of the edit step is detected at step capture phase 454. The afterRange 108 is recorded at step capture phase 456.

During step capture phase 458, the range is expanded. In particular, as part of the range expansion, the parent chain is processed during step capture phase 460, and the adjacent ranges/elements are processed during step capture phase 462. During the parent chain processing in step 460, the range is expanded to include changes between the editor DOM 26 and the store DOM 24 in the parent chain 104 of beforeRange 102 and the parent chain 104 of afterRange 108. During the processing of adjacent ranges/elements in step 462, the ranges are expanded to include changes between editor DOM 26 and store DOM 24 adjacent to beforeRange 102. This is repeated until the preceding and subsequent characters/elements in editor DOM 26 and store DOM 24 match over a required “radius” (i.e., number of characters and/or elements).

During step capture phase 464, the range is contracted by removing nodes or ranges thereof which are identical between editor DOM 26 and store DOM 24.

During step capture phase 466, a serialization is performed. The serialization comprises step capture phase 468, where the store DOM 24 is serialized in range beforeRange 102 to generate beforeText 106 (using native browser API). The serialization also comprises step capture phase 470, where the afterRange 108 of editor DOM 26 is serialized to generate afterText 110 (using native browser API).

During step capture phase 472, beforeText 106 and afterText 110 provided by browser are normalized to make sure they are identical across different browsers (even with identical DOM, different browsers generate different serializations, especially IE). If beforeText and afterText are identical (i.e. no change occurred), cancel step capture.

Finally, during step capture phase 474, beforeRange 102 is converted to beforeRange coordinates 38 (possibly changed during expand/contract steps) and afterRange 108 is converted to afterRange coordinates 39.

User 446 Begins Edit (Step 510)

FIG. 1, step capture phase 510 and FIG. 4 show a user 446 begins a replacement edit step 20, for example, by optionally selecting a range in a text document 480 and then pressing an alphanumeric key (which generates an onkeydown event 21) or the paste control key (which generates an onpaste event 432). The edit capture extension 431 services this event before the change by the user 446 begins to modify the editor DOM 26.

Record beforeRange (Step 448)

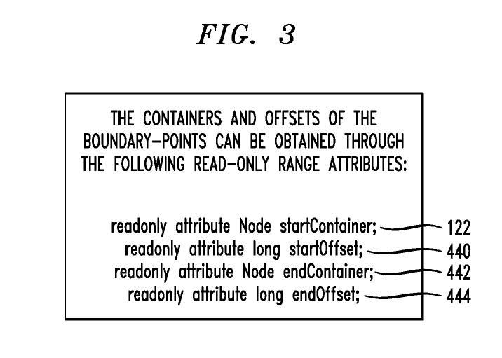

A user 446 begins a replacement edit step 20 with a selection range 124. As shown in FIG. 3, the W3C Range API (part of the W3C DOM 2 Standard) specifies that a selection range 124 is defined as a startContainer 122, startOffset 440, endContainer 442, and endOffset 444. startContainer 122 and endContainer 442 are both references (pointers) to DOM nodes while startOffset 440 and endOffset 444 are integer numbers. If startContainer 122=endContainer and startOffset=endOffset, the range is collapsed to a single insertion point. Otherwise, the user 446 began the replacement edit step 20 with a non-collapsed selection range.

References to DOM nodes are valid only in a single session of the editor 22. If two browsers deserialize the same document 480 (e.g., convert an HTML document 480 to separate DOM representations) and select the same range, the references (pointers) to DOM nodes will differ. Even in a single editor 22 session, these references may differ; for example, if a user 446 creates a DOM node, undoes the creation, and redoes the creation, references to the two nodes will be different. In order to specify a selection range 124 in a format that can be reliably reused (e.g., persisted between sessions), it must be converted to a coordinate system that doesn't depend on ephemeral references to DOM objects.

Initially, the store DOM 24 contents should match the contents of editor DOM 26. FIG. 1, step capture phase 448 and FIG. 4 show that upon an onkeydown event 21 or onpaste event 432, the edit capture extension 431 records the beforeRange 102 (startContainer 122, startOffset, endContainer, and endOffset). Element manipulation edit steps 6 typically begin with user 446 selecting a range or placing a collapsed range in an existing element and selecting a function from a toolbar or control key. For example, a user 446 may select a range “important” and press the <bold> toolbar button. Element manipulation edit steps 6 typically wrap or upwrap text nodes; or modify element attributes, rather than modifying the contents of text nodes. In the case of an element element manipulation edit step 6, the edit capture extension 431 records the beforeRange 102 before modifying the editor DOM 26, and the process continues as per that of a replacement edit step 20. Note that if the editor 22 were allowed to handle the formatting change, it may be difficult to record beforeRange 102 before the change is applied, such changes may then need to be handled as mutation events 434 (see discussion below).

beforeRange 102 may not be valid by the end of the edit. For example, the startContainer 122 or endContainer may be deleted in the course of the edit. Therefore, before allowing the edit to continue, as shown in FIG. 1, step capture phase 450 and FIG. 5, convert selection ranges 124 to selection coordinates 126; in particular, step capture phase 450 converts beforeRange 102 to beforeRange coordinates 38 (beforeRange start 134 and beforeRange end 136 are converted to beforeRange start coordinate 140 and beforeRange end coordinate 142).

Convert beforeRange (Step 450)

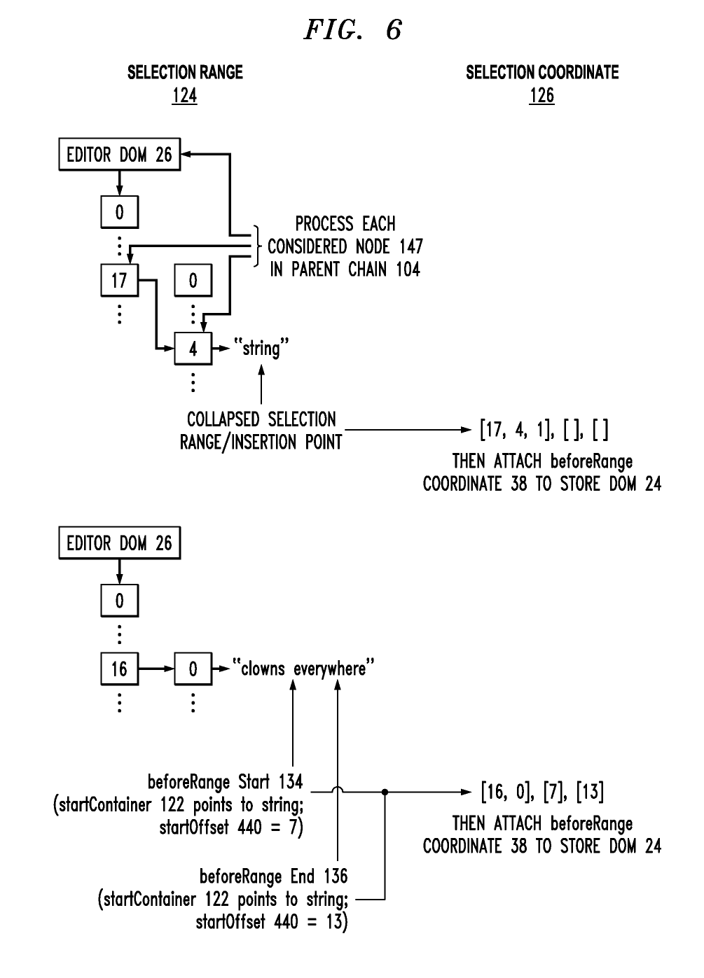

As shown in FIG. 6, during step capture phase 450, selection ranges 124 can be converted to selection coordinates 126 of the form “[17,4,1],[ ],[ ]”; which, in this case, refers to a collapsed insertion point before the first character of the fourth child of the seventeenth root node. Another example, “[16,0],[7],[13]”, refers to a range from the seventh character to the 13th character in the zero child of the sixteenth root node (this encoding is zero-based). Yet another example, “[11,0,13],[12,0,15]”, refers to a range from the thirteenth character of the zero child of the eleventh root node to the fifteen character of the zero node of the twelfth root node. If two lists are provided, the first is the start coordinate (e.g., beforeRange start coordinate 140 or afterRange start coordinate 163) which specifies the beginning of the range while the second is the end coordinate (e.g., beforeRange end coordinate 142 or afterRange end coordinate 165) which specifies the end of the range ([11,0,13] and [12,0,15], respectively, in the final example). Where three lists are provided, the first list is prepended to both the second and third lists. More generally, a DOM range 144 refers to a Container and Offset pair (such as startContainer 122 and startOffset 440) while a DOM coordinate 146 refers to means to navigate a DOM, independent of its instantiation (i.e., navigating by means of topological features of DOM rather than memory pointer references). Alternative representations to the above described coordinate system include XPath (part of the W3C XSLT Standard), which is more verbose and does not support specification of offsets into text nodes.

The conversion of a DOM range 144 to a DOM coordinate 146 proceeds as follows. Start by considering the DOM range 144 and, if inside a node, determine the offset within. Then consider the parent chain 104 of nodes from the nodes, for each level of the DOM hierarchy, starting from the level indicated by DOM range 144 and proceeding up to the root of the editor DOM 26. Navigating this parent chain 104 each considered node 147 is processed as follows:

1. Via a DOM API, obtain an ordered list of siblings of considered node 147 (the parent's children).

2. Perform a binary search to determine which of siblings is the considered node 147.

3. If parent is not root of editor, pop up one level of parent chain 104 and repeat.

In a preferred embodiment, text is divided into paragraphs which results in the conversion being relatively fast—of complexity order log(n). DOM APIs provides comparison function such as Range.compareDocumentPosition (part of the W3C DOM 2 Standard), which return whether a DOM node appears before or after another. However, in IE, this API only works when both compared nodes are elements (non-text nodes) so instead use Microsoft Internet Explorer's (IE's) proprietary API sourceIndex, which provides a global index for a given element (not just an index within a container). Using sourceIndex, one may compare two elements (the considered node 147 and the binary search node) and achieve the same result as with Range.compareDocumentPosition api.

Mediation of Edit (Step 452)

As shown in FIG. 1, step capture phase 452, a change is mediated by the editor 22 or the edit capture extension 431. In the case of a replacement edit step 20, a user 446 types without excessive pause an arbitrary number of characters/backspace/delete which are recorded in a single DOM text node. In the interest of reduced latency, reducing code complexity of edit capture extension 431, and incorporating future improvements to the capability of editor 22, this editing process may be left to be mediated by the editor 22, rather than by the edit capture extension 431.

Alternatively, especially in the case of an element manipulation edit step 6, the edit capture extension 431 mediates the element manipulation (e.g., wrap a range with a bold element) instead of allowing the editor 22 to handle the change. Note that in this case, the portion of edit capture extension 431 that mediates the change can be decoupled from the step capture portion of edit capture extension 431. More generally, any logic that mediates changes to the DOM which can later be captured by edit capture extension 431 is considered decoupled.

Detect Edit Termination (Step 454)

As shown in FIG. 1, during step capture phase 454, the edit capture extension 431 may use the following criteria to determine when a replacement edit step 20 is terminated:
user 446 pauses (e.g., at least three seconds);
user 446 clicks mouse;
user 446 navigates with keyboard (e.g., arrow keys, home/end, page up/down); or
user 446 presses a control/function key.

Determine beforeRange and afterRange

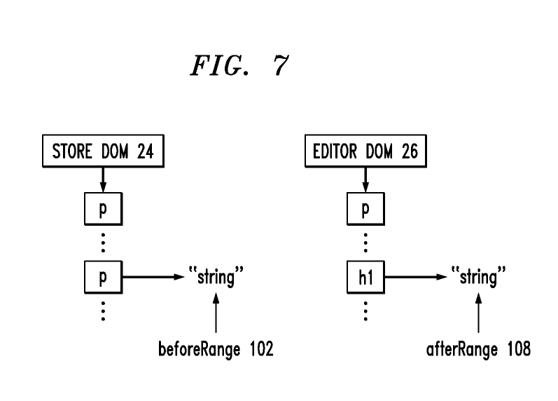

As shown in FIG. 7, during step capture phase 456, when the replacement edit step 20 is terminated, the edit capture extension 431 requests afterRange 108 from the editor 22 (consisting of afterRange start 150 and afterRange end 152). The edit capture extension 431 then adjusts the beforeRange 102 and the afterRange 108 to detect and encompass adjacent changes that would otherwise fall outside these ranges and then contracts the ranges to minimize the extents of beforeText 106 and afterText 110 (identifying a minimum change, as described in Background section).

As shown in FIG. 1, step capture phase 458, step capture phase 460, and FIG. 6, to detect and encompass adjacent changes, the edit capture extension 431 firstly looks for changes between editor DOM 26 and store DOM 24 in the parent chain 104 of the afterRange 108. A parent chain 104 is the list of ancestors of a given range (i.e., parent, grandparent, greatgrandparent, etc). Such a change can occur when a user 446 places a cursor in a text node (e.g., in a <p> element or in a <b> element therein) and presses <heading>. In this example, the beforeRange 102 is collapsed but an ancestor <p> is changed to an <h1>. The edit capture extension 431 walks up parent chain 104 and compares some or all of the content (e.g., innerhtml), element tags, and the attributes of elements in parent chain 104 of editor DOM 26 to those in parent chain 104 of store DOM 24. The outermost element that differs determines the scope of the change; beforeRange coordinates 38 and afterRange coordinates 39 are expanded to this scope. In an alternative or supplementary embodiment, the edit capture extension 431 searches the parent chain 104 of beforeRange coordinates 38 (converting beforeRange coordinates 38 to a new beforeRange 102 if the original beforeRange 102 no longer exists).

As shown in FIG. 1, step capture phase 458 and FIG. 8, to detect and encompass adjacent changes, the edit capture extension 431 secondly creates a superRange 433 consisting of the minimal range which encompasses beforeRange 102 and afterRange 108. Edit capture extension 431 then looks for changes between editor DOM 26 and store DOM 24 in text and elements adjacent to superRange 433. This is to detect changes, say, where the user 446 pressed backspace or delete to modify text or elements outside the beforeRange coordinates 38. For example, if beforeRange coordinates 38 are initially collapsed, user 446 may press backspace one or more times to merge a <p> with a preceding <p>. In each direction, if the editor DOM 26 and store DOM 24 differ in adjacent text or elements, extend beforeRange 102 and afterRange 108 accordingly in that direction and repeat above comparison process until adjacent text and elements match.

As shown in FIG. 1, step capture phase 464, edit capture extension 431 contracts boundaries of beforeRange 102 and afterRange 108 to remove from their extents content which is identical in editor DOM 26 and store DOM 24. For example, if first three characters of beforeRange 102 and afterRange 108 are identical, contract beginning boundary of beforeRange 102 and afterRange 108 by three characters. If ranges contract to a collapsed range (i.e., nothing's changed), cancel step capture. This can happen, for example, if a user 446 selects a range “apple” and types “apple”.

Serialize and Normalize Affected Range

As shown in FIG. 1, step capture phase 466, step capture phase 468, step capture phase 470 and FIG. 8, the edit capture extension 431 serializes the store DOM 24 in range beforeRange 102 to generate beforeText 106 (using native browser API). The edit capture extension 431 also serializes the afterRange 108 of editor DOM 26 to generate afterText 110 (again, using native browser API)

As shown in FIG. 1, step capture phase 472, the edit capture extension 431 normalizes the beforeText 106 and afterText 110 provided by browser to make sure all supported browsers can read them identically. Even with identical DOMs, different browsers generate different serializations, especially IE.

If beforeText 106 and afterText 110 are identical, cancel step capture. This can happen if somehow a change altered the DOM but only in a way that other browsers would consider not a change at all.

Convert Range Pointers to Range Coordinates

As shown in FIG. 1, step capture phase 474, edit capture extension 431 converts the updated beforeRange 102 and afterRange 108 to beforeRange coordinates 38 and afterRange coordinates 39, respectively using the aforementioned algorithm.

Comparison of Techniques

As shown in FIGS. 1, 5, and 6, in a preferred embodiment of the present invention, the native editor 22 (e.g. a web browser) handles selection and typing (step capture phase 452). An edit capture extension 431 (JavaScript software) then identifies edit steps 2 and encodes them in a hierarchical coordinate format 146, which include an arbitrary number of dimensions, typically expressed as integers (step capture phase 454 through step capture phase 474). In a preferred embodiment, the hierarchical coordinate format 146 is absolute (e.g., locations are encoded as distances from a canonical root, as with “DOM coordinates 146”), however, in an alternative embodiment, the edit capture extension 431 could instead encode edit steps 2 with a hierarchical coordinate format 146 that is relative (e.g., “from current location, move cursor up two levels, right three siblings, and down first child”), but, since elements at each hierarchical level are quickly found by the above-described binary search method, relative hierarchical coordinates would not provide much benefit.

Prior art (Google/Zoho/etc.) uses an absolute or relative serialized offset (typically expressed as a single integer dimension) to specify a document 480 location when applying or exchanging steps with persistence engine 438 or collaborators. An embodiment of the present invention, in contrast, uses hierarchical coordinates (arbitrary number of dimensions, each typically expressed as an integer) to specify document 480 locations when applying or exchanging steps. This is an unintuitive approach because edit steps 2 are typically sent to a persistence engine 438 which typically must be able to generate a serialized fulltext 162 (e.g., to generate a print rendering) so absolute or relative serialized offsets are a more straightforward method. Encoding edit steps 2 in a hierarchical coordinate format 146, as embodiments of the present invention propose, provides unintuitive benefits when manipulating edit steps 2 (i.e., applying or exchanging edit steps 2 with persistence engine 438 or collaborators).

Prior art Google Wave edit capture extension 431 probably mediates typing, cursor blinking, copy/cut/paste, and delete/backspace (rather than letting the native browser handle these actions as in step capture phase 452). Google Wave's approach provides much control since they then need only the basic DOM API and don't rely on browser vendors to support these actions correctly. However, the edit capture extension 431 may become more complex and may be burdened with additional work.

A hybrid approach, is for a system to use the native browser Range API (DOM2 standard) to handle blinking cursor and selection, while having an edit capture extension 431 handle all typing, copy/cut/paste, and delete/backspace events. Paste may be handled by pasting to a hidden div element then the edit capture extension 431 would copy the div contents into the document 480. Cut may be handled by moving the selected range to a hidden div element, selecting it, then allowing the browser to copy the selection.

Either the Google Wave or the hybrid approach would simplify step capture since the edit capture extension 431 wouldn't have to search parent chain 104 or adjacent nodes to identify a minimum change; all edit steps 2 would be processed similar to how element manipulation edit steps 6 would be processed. This would obviate the need for a store DOM 24, reducing memory requirements and improving performance.

Convert DOM Coordinates to String Index on Persistence Engine 438

If the editor 22 persists one or more edit steps 2 to a persistence engine 438, it can be helpful for persistence engine 438 to maintain a cached representation of the document 480 being edited by the editor 22. Such a cached document 482 representation can be used to ensure user 446-persisted beforeTexts match expections of the persistence engine 438. If beforeText 106 in edit step 2 differs from what persistence engine 438 finds in its cached document 482 at that location, the edit step 2 may be rejected. Such a cached document 482 can also be used to ensure the documents conform to requirements of HTML, SVG, etc.

The persistence engine 438 can maintain cached document 482 in a serialized fulltext 162 and/or DOM representation (other formats may also be appropriate). While the editor 22 must maintain a DOM representation in order to render it to the editor 22 display, there's no such need on the persistence engine 438. Since a serialized fulltext 162 representation is more compact (approximately ⅓ the size in memory of a DOM representation) and is faster to manipulate (at least for some operations such as range comparison), one may prefer to use a serialized fulltext 162 representation on the persistence engine 438.

1. Persistence engine 438 maintains current version of sections 457 as serialized fulltexts 162 (each as a string).

2. Persistence engine 438 converts beforeRange start coordinate 140 to serial index 164 which is an offset into the serialized fulltext 162.

3. Upon edit step 2 persistance, undo, redo, or revert, persistence engine 438 updates fulltext 162 by applying/unapplying changes at specified serial index 164.

Only One DOM Coordinate Necessary

It is possible to persist only one DOM coordinate, say beforeRange start 134, and regenerate others when necessary by calculating the size of beforeText 106 and afterText 110 (in both text node offset and element coordinates). For example, if beforeText 106=“apple”, beforeRange end coordinate 142 will have the same coordinate as beforeRange start coordinate 140 plus a final offset of 5. If beforeText 106 were instead “apple <b>pie” and beforeRange start coordinate 140 were [16,0,7] (the seventh character in the zero child of the sixteenth root node), beforeRange end coordinate 142 could be calculated to be [16,1,0,3] (the third character in the first child of the sixteenth root node).

The afterRange start coordinate 163 can be considered equivalent to beforeRange start coordinate 140 (though there are situations where, due to browser strangenesses, they differ). afterText 110 can then be used to calculate afterRange end coordinate 165. Therefore only one coordinate plus beforeText 106 and afterText 110 is required to regenerate the other three coordinates. However, in a preferred embodiment, all four coordinates are persisted because it can be computationally expensive to regenerate them. Three coordinates may be thought of as cached values. Alternatively, with afterText 110, beforeRange start 134 and beforeRange end 136, one may can calculate beforeText 106 and the two afterRange coordinates 39 on persistence engine 438.

Non-Breaking Space in Otherwise-Empty Dom Node Makes it Navigable The edit capture extension 431 may encode the user 446 pressing <enter> in an element (e.g., a paragraph or list item node) as either a <br/> or as splitting the element. Google Documents, for example, encodes them as <br/>'s. In a preferred embodiment of the present invention, <enter> is encoded as splitting the element. The advantage of splitting the element is that large documents are thereby broken up into manageable chunks which streamlines step capture. For example, if a large document 480 were contained in one element, the range coordinates could devolve into simple string indices and the edit capture extension 431 could require additional time to look for changes between editor DOM 26 and store DOM 24 in text and elements adjacent to the range specified by beforeRange 102. In one extreme, the edit capture extension 431 must then expensively calculate a difference between the fulltext serializations of the store DOM 24 and the editor DOM 26. Splitting paragraph elements also follow the spirit of the HTML specification more faithfully and, in may cases, are required to match the expected output format (e.g., the USPTO expects filed patents to use numbered paragraphs, which is facilitated if the document 480 is partitioned into paragraphs). A hybrid option is possible which encodes a first <enter> as a <br/> and a second <enter> at that location absorbs the <br/> and splits the paragraph.

In the case where <enter> is encoded as splitting an element, if the user 446 is at the end of an element when pressing <enter>, a new, empty element is created. If the step is terminated before the user 446 types into the empty element, the element may be undesirably hidden by the editor 22, since the HTML specification says to hide empty nodes. This forces the user 446 to create new elements and type some content in them in a single step (e.g., without pausing long enough for the edit capture extension 431 to trigger a step termination).

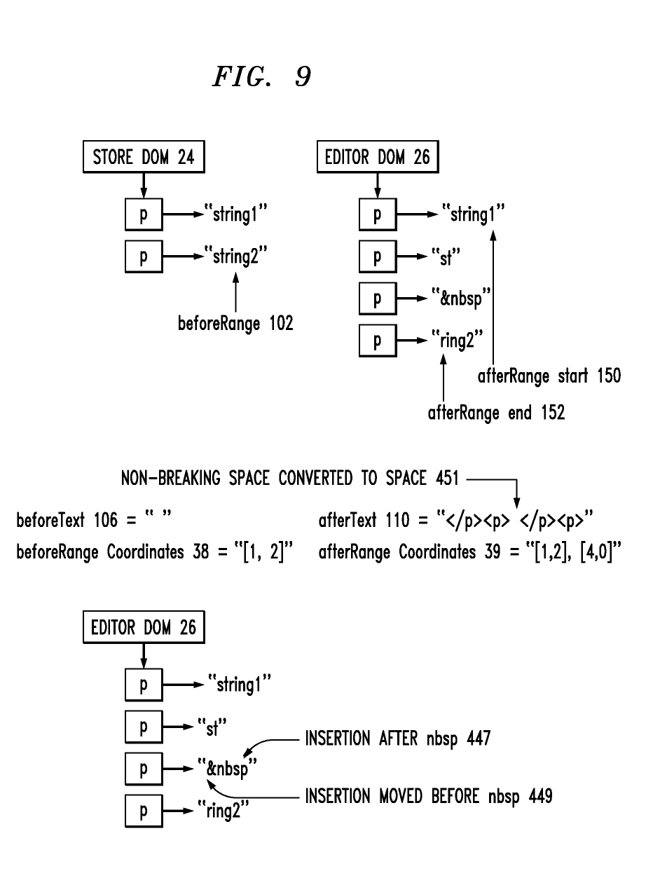

This timing requirement is undesirable so, in a preferred embodiment and as shown in FIG. 9, upon creating a new element, the edit capture extension 431 automatically places some content in the otherwise empty element. Content that doesn't produce a visible artifact is preferable so, a preferred embodiment automatically places a non-breaking space (“&nbsp;”) in the otherwise empty element. Other non-printing characters such as a zero-width space may alternatively be used though there are some tradeoffs (note that a regular space will cause browser to hide a paragraph).

To avoid such special characters becoming part of the persisted document 480, as part of normalizing the affected range when persisting, otherwise empty elements containing a special character (such as a non-breaking space) may have the special character transformed to a regular space (non-breaking space converted to space 451). In these cases, upon application of the step, say when a collaborator in another editor 22 receives the change, an element containing just a normal space is transformed to an element containing the special character (e.g., a non-breaking space).

However, if the user 446 clicks at the end of the empty paragraph in which a non-breaking space has been automatically inserted (insertion after nbsp 447), there will be an undesired leading space. To handle this issue, the edit capture extension 431 automatically shifts the insertion point to the beginning of the element when the user 446 arrows or clicks into an element containing just a space (insertion moved before nbsp 449).

Mutation Events

Some editors 22 provide events triggers for mutation events 434 which are any changes to the DOM. These can be used to handle changes that aren't handled by edit capture extension 431. For instance, in Firefox when the browser's spell check facility is turned on, the user 446 right clicks on a misspelt word, and selects an alternative spelling suggestion, a mutation event 434 is generated. Other instances include resizing an inline image by dragging a handle. Note that mutation events 434 are also generated for the above-described replacement edit steps 20, but, since the edit capture extension 431 is expecting them, are ignored by edit capture extension 431.

Processing a mutation event is similar to a normal edit step 2 but there is less certainty when determining the beforeRange 102. Typically, the mutation event trigger is handled after the change has been applied to the editor DOM 26. To determine the beforeRange 102 accurately, the entire store DOM 24 might need to be compared to the entire editor DOM 26, which would slow performance. So mutation events 434 are not the preferred edit step 2 capture method but are useful for changes which cannot be captured any other way.

Group Related Edit Steps

Some edit steps 2 involve changes to multiple locations in a document 480. For example, in an edit capture extension 431 adapted for patent preparation, typing “roller 20 and workpiece 20” might result in “roller 20” and “workpiece 20” being tagged as inconsistent part references, resulting in a range “<a class=“conflict”>roller 20</a> and <a class=“conflict”>workpiece 20</a>”. In a preferred embodiment, two edit steps 2 would be persisted: the typed text in one step and the two links in the second step. Note that the two links are separated in the document 480 by other “unlinked” text, so the previously described edit step 2 encoding could not encode both in a single edit step 2. In a preferred embodiment, each part reference link is encoded in a separate edit step 2 and the two are then bundled as substeps 455 into a group step 436. Note that group steps 436 are generated rather than captured since such changes are not handled by generic editors 22.

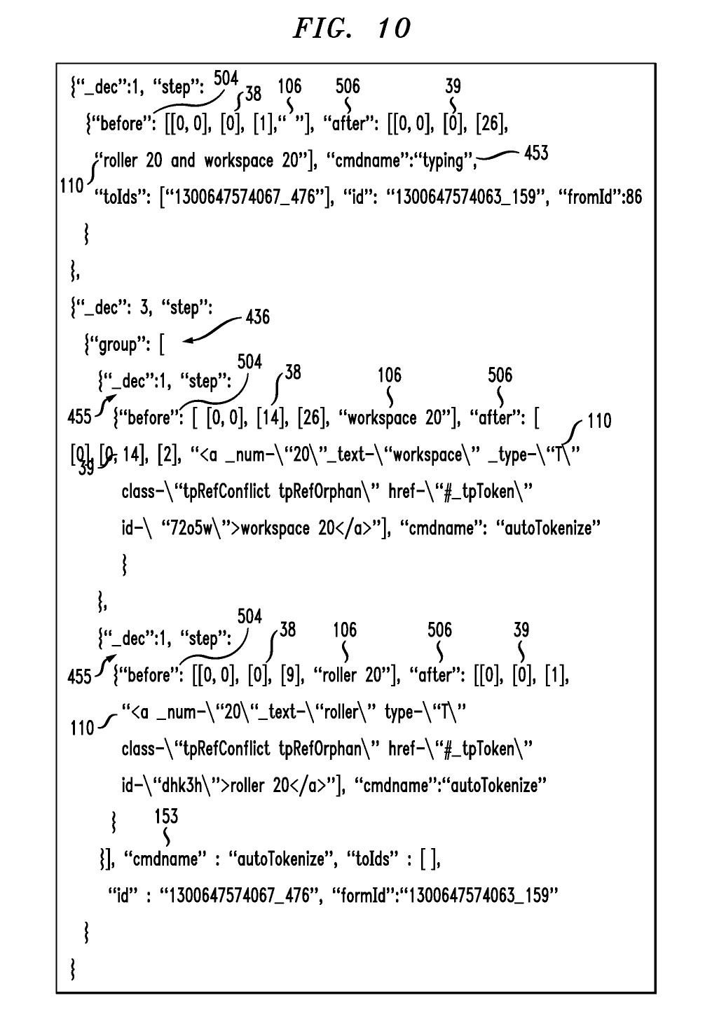

FIG. 10 shows the edit steps 2 created by an embodiment of the present invention where a user 446 typed “roller 20 and workpiece 20” in an otherwise empty document 480. It contains a first step containing the users typing (cmdname 453=“typing”) and a group step 436 containing two substeps 455, each linking one of the parts (cmdname 453=“autoTokenize”). beforeStep 504 (labeled “before”) includes beforeRange coordinate 38 and beforeText 106 while afterStep 506 (labeled “after”) includes afterRange coordinates 39 and afterText 110.

Group steps 436 allow related changes to be undone/redone as a group, which is particularly important if undoing/redoing a subset of the group would leave the document 480 in an invalid state. In the example of FIG. 10, a group substep links “workspace 20” as part reference whose name conflicts with another part reference sharing reference numeral “20”. If this substep were applied independently from the following substep, which links conflicting part reference “roller 20”, the conflict warning would not be supported by two linked parts sharing a reference numeral and differing in name. The substeps should be applied or unapplied as a group.

As another example, if textual part reference is in an “unsupported” state when a corresponding drawing callout is placed, a group step 436 is created changing the textual part reference to valid and, at the same time, placing a valid drawing callout.

Steps Applied/Unapplied in Lieu of Native Undo/Redo Functionality

The above described edit steps 2 are symmetrical so can be undone by inverting before and after (i.e., replace afterText 110 at afterRange 108 with beforeText 106). In a preferred embodiment, the edit capture extension 431 overloads the editor 22 native undo/redo functionality with custom functionality that apply steps (redo) or the inverses thereof (undo).

An advantage of such an approach is that undo/redo may then work for operations that the native undo/redo capability could not. For example, group steps 436 may then be undone/redone as a set. An edit step 2 manipulating a non-text section (e.g., placing a drawing callout), may then be intuitively undone/redone.

If the document 480 consists of multiple sections 457, each with a separate DOM (e.g., a patent application may consist of a text section 478 and an arbitrary number of annotated Scalable Vector Graphic (SVG) drawing sections 476), each section 457 may maintain its own undo/redo queue 508 or there may be a monolithic undo/redo queue 508 for all sections 457. Additionally, if there are multiple users 446 collaborating on a document 480 and a first user 446 presses undo, the system can revert the most recent change made by said first user 446 (i.e., a local undo/redo queue 508) or the most recent change made by any user 446 (i.e., a global undo/redo queue 508). Recapping, when multiple users simultaneously edit a document 480 containing multiple sections 457, and one user 446 presses undo, the system may do one of the following:

1. undo the most recent change made by any user 446 in most recently changed section 457;

2. undo the most recent change made by any user 446 in focused section 457 of current user 446 or, if no section 457 is focused, in section 457 most recently changed by current user 446 (i.e., he who pressed undo, which is the same as #1 but each section 457 is treated as a separate document 480);

3. undo the most recent change made by current user 446 (i.e., he who pressed undo) in section 457 most recently changed by current user 446; or

4. undo the most recent change made by current user 446 (who pressed undo) in focused section 457 of current user 446 or, if no section 457 is focused, in section 457 most recently changed by current user 446 (i.e., he who pressed undo).

For example, FIG. 11 shows that user X makes change 484 to text section 478, user X makes change 486 to drawing section 476 then user Y makes change 488 to drawing section 476 then user Y makes change 490 to text section 478. If user X refocuses in text section 478 and presses undo, the system may undo change 490 which is most recent (option 1), undo change 488 which is the most recent in drawing section 476 (option 2), undo change 486 which is the most recent by user X (option 3), or undo change 484 which is the most recent by user X in currently-focused section (option 4).

An advantage of a monolithic, global undo/redo queue 508 is that the sections 457 may more easily be kept in synchronization. This can be important if, for example, the statuses of a callout in a drawing section 476 and a part reference in a text section 478 are coordinated—undoing the drawing callout independently would leave an inconsistency in the textual part reference status. In a preferred embodiment, a monotlithic, global undo/redo queue 508 is maintained for all sections 457 of a document 480.

Branching with Redo

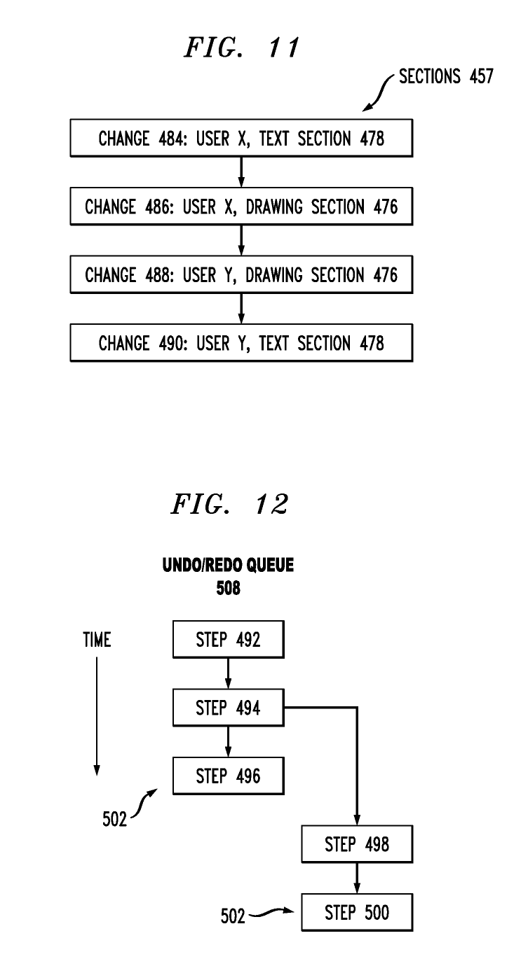

As shown in FIG. 12, suppose a document 480 history consists of 3 typing steps (step 492, step 494, step 496). When a user 446 presses undo, the persistence engine 438 records the new current revision (step 494). If the user 446 then creates two new edit steps 2, step 498 and step 500 (step 498 is persisted as being a child of step 494). If the user 446 then presses undo twice, the current revision becomes step 494. If the user 446 then presses redo, it is ambiguous as to whether the persistence engine 438 should redo step 496 or step 498. Some version control systems such as Perforce require the user 446 manually jumping forward to a version when it's possible to jump forward to multiple branches (i.e., when it's ambiguous as to which branch is desired).

In a preferred embodiment, the persistence engine 438 records a leaf node version 502 of the most recently visited branch. In the above case, the server would remember leaf node version 502=step 500 was the most-recently visited branch. This would disambiguate which branch should be followed upon redo. This approach supports intuitively and incrementally redoing steps through otherwise ambiguous junctures. This capability allows simple undo/redo navigation in most cases while supporting arbitrary branch jumping through another interface (e.g., reverting to an arbitrary step number in a revision history browser).

System Topology

FIG. 2 illustrates a computer system 400 which may suitably embody one implementation of the invention. Computer system 400 includes a bus 402 or other communication mechanism for communicating information, and a processor 404 coupled with bus 402 for processing information. Computer system 400 also includes a main memory 406, such as a random access memory (RAM) or other dynamic storage device, coupled to the bus 402 for storing information and instructions to be executed by processor 404. Main memory 406 also may be used for storing temporary variables or other intermediate information during execution of instructions to be executed by processor 404. Computer system 400 further includes a read only memory (ROM) 408 or other static storage device coupled to bus 402 for storing static information and instructions for processor 404. A storage device 410, such as a magnetic disk or optical disk, is provided and coupled to bus 402 for storing information and instructions such as edit capture extension 431. The main memory 406 could be distributed or local and the processor 404 could be distributed or singular. It should also be noted that some or all of computer system 400 can be incorporated into a personal computer, laptop computer, handheld computing device.

Computer system 400 may be coupled via bus 402 to a display 412, such as a cathode ray tube (CRT), liquid crystal display (LCD), or the like, for displaying information to a computer user 446. An input device 414, including alphanumeric and other keys, is coupled to bus 402 for communicating information and command selections to processor 404. Another type of user 446 input device is a cursor control 416, such as a mouse, a trackball, or cursor direction keys for communicating direction information and command selections to processor 404 and for controlling cursor movement on display 412.

The invention is related to the use of computer system 400 modified as described herein for implementing the techniques described herein. According to one embodiment of the invention, those techniques are performed by computer system 400 in response to processor 404 executing one or more sequences of instructions contained in main memory 406. Such instructions may be read into main memory 406 from another machine readable medium, such as the storage device 410. Execution of the sequences of instructions contained in main memory 406 causes processor 404 to perform the process steps described herein. In alternative embodiments, hard wired circuitry may be used in place of or in combination with software instructions to implement the invention. Thus, embodiments of the invention are not limited to any specific combination of hardware circuitry and software.

The term “machine readable medium” as used herein refers to any medium that participates in providing data that causes a machine to operation in a specific fashion. In an embodiment implemented using computer system 400, various machine readable media are involved, for example, in providing instructions to processor 404 for execution. Such a medium may take many forms, including but not limited to, non-volatile media, volatile media, and transmission media. Non-volatile media includes, for example, optical or magnetic disks, such as storage device 410. Volatile media includes dynamic memory, such as main memory 406. Transmission media includes coaxial cables, copper wire and fiber optics, including the wires that comprise bus 402.

Common forms of machine readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of machine readable media may be involved in carrying one or more sequences of one or more instructions to processor 404 for execution. For example, the instructions may initially be carried on a magnetic disk of a remote computer. The remote computer can load the instructions into its dynamic memory and send the instructions over a telephone line using a modem. A modem local to computer system 400 can receive the data on the telephone line and use an infrared transmitter to convert the data to an infrared signal. An infrared detector can receive the data carried in the infrared signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two way data communication coupling to a network link 420 that is connected to a local network 422. For example, communication interface 418 may be an integrated services digital network (ISDN) card or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the Internet 428. Local network 422 and Internet 428 both use electrical, electromagnetic or optical signals that carry digital data streams. The signals through the various networks and the signals on network link 420 and through communication interface 418, which carry the digital data to and from computer system 400, are exemplary forms of carrier waves transporting the information.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, or stored in storage device 410, or other nonvolatile storage for later execution. In this manner, computer system 400 may obtain application program code in the form of a carrier wave.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A method for editing a document, comprising:
obtaining an editor document object model (editor DOM) version of the document, wherein the editor DOM can be modified by a user and comprises a plurality of nodes in a DOM hierarchy representing elements of the document;
encoding a change to said editor DOM using an edit capture extension in a hierarchical coordinate format to identify a location of said change; and
transferring said encoded change to at least one of a collaborator and a persistence engine.

2. The method of claim 1, wherein said hierarchical coordinate format has a number of dimensions that is proportional to a nesting depth of said editor DOM at a location of said change.

3. The method of claim 1, wherein said change is mediated by said edit capture extension.

4. The method of claim 1, wherein said change is mediated by a native editor and identified by said edit capture extension.

5. The method of claim 1, further comprising the step of encoding a first <enter> function as a break element and a second <enter> function at a same location in said document as said first <enter> function replaces the break element and splits the element.

6. A method for editing a document, comprising:
obtaining an editor document object model (DOM) version of the document, wherein the editor DOM can be modified by a user and comprises a plurality of nodes in a DOM hierarchy representing elements of the document;
identifying a change to said editor DOM using an edit capture extension by comparing differences between said editor DOM and a store DOM version of the document; and
reflecting said identified change in the store DOM.

7. The method of claim 6, wherein said change is mediated by a native editor and identified by said edit capture extension.

8. The method of claim 7, wherein said native editor is a web browser.

9. The method of claim 6, further comprising the step of encoding a first <enter> function as a break element and a second <enter> function at a same location in said document as said first <enter> function replaces the break element and splits the element.

10. The method of claim 6, further comprising the step of requesting a beforeRange associated with said change before said user begins said editing.

11. The method of claim 6, wherein said change is terminated by one or more of a pause, mouse click, keyboard navigation and pressing of a control/function key.

12. The method of claim 11, further comprising the step of requesting an afterRange associated with said change after said termination.

13. The method of claim 6, further comprising the step of adjusting a beforeRange and an afterRange associated with said change to detect and encompass adjacent changes that may fall outside the beforeRange and the afterRange.

14. The method of claim 6, further comprising the step of comparing said editor DOM and said store DOM in a parent chain of at least one of a beforeRange and an afterRange associated with said change in a superRange consisting of an approximately minimal range encompassing the beforeRange and the afterRange.

15. The method of claim 6, further comprising the step of extending one or more boundaries of a beforeRange and an afterRange associated with said change to include the identified change.

16. The method of claim 6, further comprising the steps of comparing contents of a beforeRange associated with said change in the store DOM and an afterRange associated with said change in the editor DOM and contracting boundaries of the beforeRange and the afterRange to remove identical content.

17. The method of claim 6, further comprising the step of determining a beforeText associated with said change from the store DOM using a beforeRange associated with said change.

18. The method of claim 6, wherein the step of reflecting said identified change in the store DOM further comprises the step of encoding a DOM coordinate that is generated by calculating an offset within an innermost element and, for each considered node in parent chain, obtaining an ordered list of siblings, and determining a position of the considered node among the siblings.

19. The method of claim 6, further comprising the step of serializing the store DOM in a beforeRange associated with said change.

20. The method of claim 6, further comprising the step of serializing the editor DOM in an afterRange associated with said change.

21. The method of claim 6, further comprising the step of normalization of a serialization in one or more of a beforeRange associated with said change and an afterRange associated with said change to ensure supported browsers can read them identically.

22. The method of claim 21, wherein a persistence engine maintains a cached document representation of the store DOM contents.

23. The method of claim 21, further comprising the step of rejecting a change if a beforeText differs from the cached document representation at a location specified by a beforeRange.

24. The method of claim 22, wherein the cached document representation is maintained in a serialized full text representation.

25. The method of claim 24, further comprising the step of converting, by a persistence engine, at least one DOM coordinate to a serial index.

26. The method of claim 6, wherein a first <enter> function is encoded as a break element and a second <enter> function at a same location in said document as said first <enter> function replaces the break element and splits the element.

27. The method of claim 6, further comprising the step of placing one or more special characters in an otherwise empty element, upon creating a new element, to prevent the new element from being hidden.

28. The method of claim 27, further comprising the step of converting special characters in an edit step to normal characters before transferring an encoded change to a persistence engine.

29. The method of claim 27, further comprising the step of shifting an insertion point to a beginning of an element upon navigating to the end of an otherwise empty element containing a special character.

30. The method of claim 6, further comprising the step of capturing an edit step upon an unexpected mutation event.

31. The method of claim 6, further comprising the step of maintaining a global undo/redo queue that is uniformly applied to all collaborators.

32. The method of claim 6, further comprising the step of maintaining a monolithic undo/redo queue for multiple sections of the editor DOM.

33. The method of claim 6, further comprising the steps of recording at a persistence engine a leaf node version of most recently visited branch; and upon a user actuating a redo function at a revision juncture, moving to a branch leading to the leaf node version.

34. A method for editing a document, comprising:
obtaining at least one editor document object model (DOM) version of the document, wherein the at least one editor DOM can be modified by a user and comprises a plurality of nodes in a DOM hierarchy representing elements of the document; and
grouping a plurality of related changes to said at least one editor DOM as a group step, wherein said plurality of related changes in said group step are from one or more of non-contiguous regions of said document and a plurality of editor DOMs, and wherein said plurality of changes in said group step can be one or more of undone and redone as a group.

35. The method of claim 34, further comprising the step of encoding a first <enter> function as a break element and a second <enter> function at a same location in said document as said first <enter> function replaces the break element and splits the element.
